(19) United States
(12) Patent Application Publication
(10) Pub. No.: US 2019/0178781 A1
(43) Pub. Date: Jun. 13, 2019

(54) AIR PARTICLE DETECTING DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: QI-MING WU, Shenzhen (CN); JUN-WEI YANG, Shenzhen (CN); YU-CHIAO HUANG, New Taipei (TW); SHUN-CHUAN YANG, New Taipei (TW)

(21) Appl. No.: 15/943,686

(22) Filed: Apr. 2, 2018

(30) Foreign Application Priority Data
Dec. 8, 2017 (CN) 201721708744.4

(51) Int. Cl. G01N 15/12; G01N 15/02

(52) U.S. Cl. CPC G01N 15/1227; G01N 21/47; G01N 15/0211

(57) ABSTRACT

An air particle detecting device includes a main body, a processor received in the main body, and an air particle counter received in the main body. The air particle counter is electrically coupled to the processor. The air particle counter is configured to calculate data related to a quantity of particulate matter and transmit the data to the processor. The processor is configured to calculate a concentration of PM 2.5 according to the data.

### FIELD

The subject matter herein generally relates to electronic devices, and more particularly to an electronic device having an air particle counter.

### BACKGROUND

Generally, air quality is influenced by particulate matter (“PM”) floating in the air. Particularly, PM2.5 particles, often described as fine particles, are 2.5 micrometers in diameter or smaller, and can adversely impact air quality and health conditions. Accordingly, people may want to know the air quality wherever they are at.

### BRIEF DESCRIPTION OF THE DRAWINGS

Implementations of the present disclosure will now be described, by way of example only, with reference to the attached figures.

FIG. 1 is diagram of an exemplary embodiment of an air particle detecting device in accordance with an embodiment of the present disclosure.

FIG. 2 is another diagram of the air particle detecting device of FIG. 1.

FIG. 3 is another diagram of the air particle detecting device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

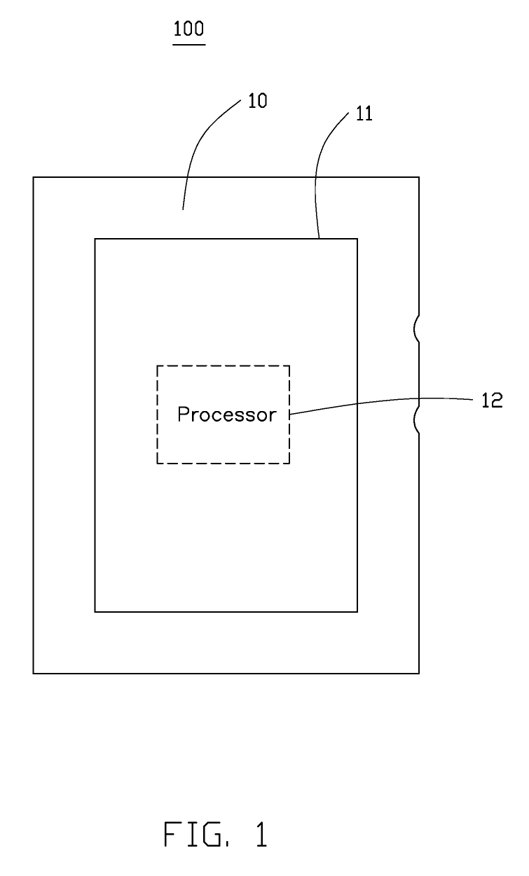

FIG. 1 illustrates an embodiment of an air particle detecting device 100 (hereinafter “the device 100”). The device 100 can be a tablet computer, a mobile phone, a smart watch, or any suitable portable electronic device. The device 100 includes a main body 10, a display 11, a processor 12, and an air particle counter 14. The display 11 is arranged on a side of the main body 10 and is used for displaying information for a user, such as a concentration of PM 2.5 particles. The processor 12 is arranged within the main body 10.

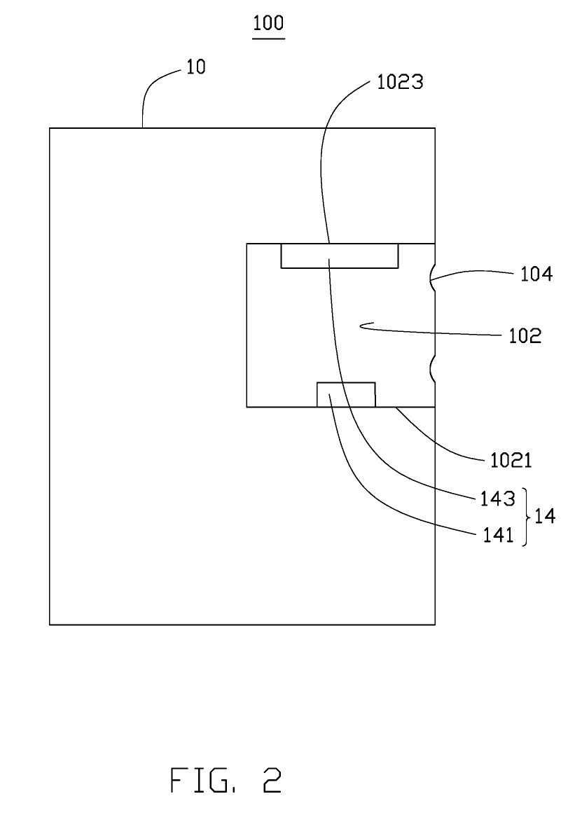

Referring to FIG. 2, the main body 10 defines a receiving space 102 for receiving the air particle counter 14. In detail, the receiving space 102 is a space defined in a side of the main body 10. The receiving space 102 is bound by at least a first surface 1021 and a second surface 1023. The second surface 1023 is opposite to the first surface 1021. The first surface 1021 and the second surface 1023 are coupled together by a sidewall (not labeled). The air particle counter 14 is arranged within the receiving space 102 and is used for obtaining data corresponding to a quantity of air particles of one or more predetermined sizes. The main body 10 defines at least one air inlet 104 communicating with the receiving space 102. The air inlet 104 allows air to flow into the receiving space 102. In at least one embodiment, the main body 10 defines two air inlets 104. One air inlet 104 is adjacent to the first surface 1021, and the other air inlet 104 is adjacent to the second surface 1023. Each air inlet 104 communicates with the receiving space 102 to allow air from different directions enter into the receiving space 102. Thus, air is more evenly distributed within the receiving space 102. Of course, there may be two or more of the air inlet 104 in another embodiment.

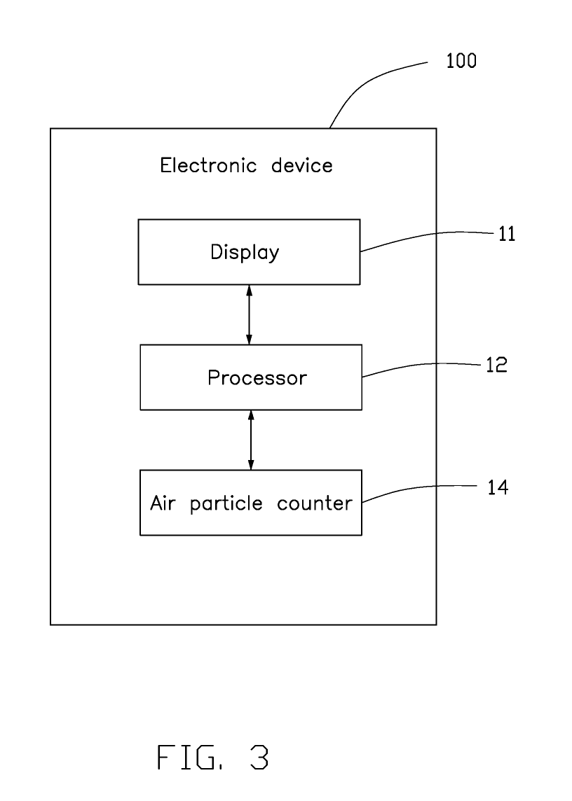

Referring to FIG. 3, the processor 12 is electrically coupled to the display 11 and the air particle counter 14. The processor 12 is used to process data gathered by the device 100, such as a particle number concentration of PM 2.5 particles, in order to calculate the concentration of PM 2.5 particles.

Referring again to FIG. 2, the air particle counter 14 includes a laser source 141 and a photodetector 143. The laser source 141 is arranged on the first surface 1021 and is used for emitting light toward the photodetector 143. When air enters the receiving space 102 through the air inlet 104, light emitted from the laser source 141 is intercepted by air particles containing particulate matter, thereby causing scattered light. The photodetector 143 arranged on the second surface 1023 is used for receiving or sensing the scattered light and generating corresponding pulse signals. When the air inside the receiving space 102 includes air particles containing PM of certain sizes, a portion of the laser beam will be scattered by the PM. The scattered light forms diffraction rings of different radii and intensities. A radius of the diffraction rings corresponds to a diameter of the PM, and an intensity of the diffraction rings corresponds to a quantity/concentration of the PM. For example, when the PM are smaller, the radii of the diffraction rings are bigger. When the quantity of the PM of the same size is larger, the intensity of the diffraction rings of the same size is greater. Each size of PM corresponds to a radii of the diffraction rings. The photodetector 143 receives the diffraction rings and generates pulse signals according to the intensities and radii of the various diffraction rings. The photodetector 143 transmits the pulse signals to the processor 12. The processor 12 receives the pulse signals and processes the pulse signals, such as by enlarging and filtering the pulse signals and then converting the pulse signals into numerical data. In detail, the processor 12 converts the pulse signals into numerical signals to determine intensity values of diffractions rings having different radii. In this way, the diameter of the particle is determined according to the radius of the diffraction ring, and the quantity of the particle is determined according to the intensity value. The processor 12 determines the particle number concentration of PM 2.5 according to a size of the receiving space 102 and the quantity of PM 2.5 particles in the receiving space 102, since the concentration is related to the size of the receiving space 102. Finally, the processor 12 converts the particle number concentration of PM 2.5 into a concentration having standard units and displays the concentration on the display 11.

The device 100 uses the air particle counter 14, the processor 12, and the display 11 to allow a user to know the concentration of PM 2.5 particles anywhere they go. Thus, a separate air particle counter is not necessary.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An air particle detecting device comprising:
a main body;
a processor received in the main body; and
an air particle counter received in the main body and electrically coupled to the processor;
wherein the air particle counter in combination with the processor are configured to calculate a concentration of PM 2.5.

2. The air particle detecting device of claim 1, wherein a receiving space is defined in a side of the main body for receiving the air particle counter therein.

3. The air particle detecting device of claim 2, wherein the receiving space is bound by a first surface and a second surface; the first surface is opposite to the second surface and coupled by a side surface.

4. The air particle detecting device of claim 3, wherein at least one air inlet in communication with the receiving space is defined in a side of the main body for allowing air to enter the receiving space.

5. The air particle detecting device of claim 4, wherein two air inlets are defined in the main body; one air inlet is adjacent to the first surface, and the other air inlet is adjacent to the second surface.

6. The air particle detecting device of claim 4, wherein the air particle counter comprises a laser source and a photodetector; the laser source is arranged on the first surface, and the photodetector is arranged on the second surface; the laser source emits light toward the photodetector.

7. The air particle detecting device of claim 6, wherein light emitted by the laser source is intercepted by particulate matter (PM) to create scattered light; the photodetector receives the scattered light, generates corresponding pulse signals and transmits the pulse signals to the processor.

8. The air particle detecting device of claim 7, wherein the scattered light on the photodetector forms diffraction rings having different radii and intensities; the photodetector collects the diffraction rings and generates different pulse signals according to the different intensities of the diffraction rings having different radii.

9. The air particle detecting device of claim 8, wherein the processor and the photodetector are electrically coupled together; the processor processes the pulse signals to obtain intensity values of diffraction rings having different radii; a diameter of PM in the receiving space is determined according to the radii of the diffraction rings; a quantity of the PM having different radii in the receiving space is determined according to the intensity value of the diffraction rings.

10. The air particle detecting device of claim 9, wherein the processor calculates the quantity of PM 2.5 air particles in the receiving space, then calculates a particle number concentration of PM 2.5 particles according to a size of the receiving space; the processor converts the particle number concentration of PM 2.5 particles into official units of a concentration of PM 2.5 particles.

11. The air particle detecting device of claim 10, further comprising a display electrically coupled to the processor; wherein the display displays the concentration of PM 2.5 particles.
